(19) United States
(12) Patent Application Publication
(10) Pub. No.: US 2011/0292852 A1
(43) Pub. Date: Dec. 1, 2011

(54) Method of Optimizing Power Saving and Related Communication Device

(76) Inventor: Mamadou Kone, Taoyuan County (TW)

(21) Appl. No.: 12/952,103

(22) Filed: Nov. 22, 2010

Related U.S. Application Data
(60) Provisional application No. 61/286,395, filed on Dec. 15, 2009.

(51) Int. Cl. H04W 52/02

(52) U.S. Cl. 370/311

(57) ABSTRACT

A method for optimizing power saving for a mobile device in a wireless communication system is disclosed. The method includes maintaining a battery power status of the mobile device; and sending the battery power status of the mobile device to a network when the battery power status is less than a threshold value.

### CROSS REFERENCE TO RELATED APPLICATIONS

This application claims the benefit of U.S. Provisional Application No. 61/286,395, filed on Dec. 15, 2009 and entitled “Methods for optimizing Power saving for UE with low Battery level”, the contents of which are incorporated herein.

### BACKGROUND OF THE INVENTION

1. Field of the Invention

The application relates to a method used in a wireless communication system and related communication device, and more particularly, to a method for optimizing Power saving in a wireless communication system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as user equipments (UEs).

A discontinuous reception (DRX) functionality is applied to a media access control (MAC) layer for allowing the UE to enter a standby mode during certain periods of time and stopping monitoring a Physical down Link Control Channel (PDCCH), so as to reduce power consumption of the UE. In cases of using the DRX functionality, whenever a new DRX cycle begins, an On Duration Timer is started for awaking the UE to monitor the PDCCH until the On Duration Timer expires. In addition, when a DRX Inactivity Timer or a DRX Retransmission Timer is started, the UE also monitors the PDCCH.

A proper analysis of the performance of procedures associated to common channels (e.g. random access, paging and broadcast channels) can help to improve the overall system performance. Currently, the UE with a low battery power may easily run out of power if no network parameter setting and configuration change is applied to optimize its system performance. In addition, user's experience and/or network performance can be degraded by suboptimal configuration of common channels. In this situation, the UE with a certain low battery power should not be loaded with some signaling or asked to transmit some measurement at the same pace as powered UE. When the eNB continues to use the suboptimal configuration even for a UE with a low battery level, the battery of the UE may quickly run out if normal DRX cycle is applied as for UE with a good battery power.

### SUMMARY OF THE INVENTION

A method of optimizing power saving for a mobile device in a wireless communication system and related communication device are provided.

A method for optimizing power saving for a mobile device in a wireless communication system is disclosed. The method comprises maintaining a battery power status of the mobile device; and sending the battery power status of the mobile device to a network when the battery power status is less than a threshold value.

A method for optimizing power saving for a network in a wireless communication system is disclosed. The method comprises receiving a low battery power status from a mobile device; and sending a first command to the mobile device to change a first configuration of the mobile device to a second configuration according to the low battery power status.

A system for power saving in a mobile device is disclosed. The system comprises a processor, a storage component, a communications component, a status component, and a trigger component. The communications component is configured to communicate with a network. The status component is configured to maintain a battery power status of the mobile device. The trigger component is configured to decide sending the battery power status of the mobile device to the network when battery power status is less than a threshold value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary wireless communication system.

FIG. 2 is a schematic diagram of an exemplary communication device.

FIG. 3 illustrates a schematic diagram of the program code shown in FIG. 2.

FIG. 4 is a flow chart of an exemplary process.

FIG. 5 is a flow chart of an exemplary process.

FIG. 6 is a flow chart of an exemplary process.

### DETAILED DESCRIPTION

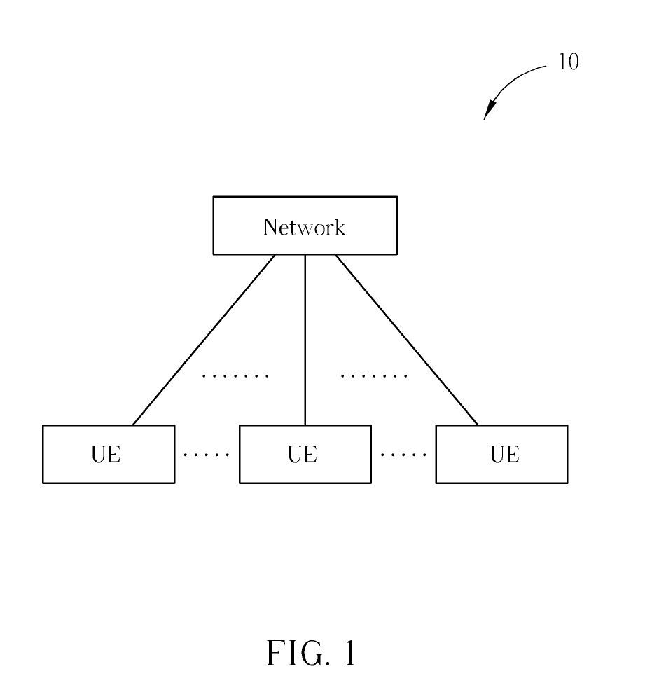

Please refer to FIG. 1, which is a schematic diagram of an exemplary wireless communication system 10. The wireless communication system 10, such as an LTE (long-term evolution) system or other mobile communication systems, is briefly composed of a network and a plurality of user equipments (UEs). In FIG. 1, the network and the UEs are simply utilized for illustrating the structure of the wireless communication system 10. Practically, the network can be referred as to an E-UTRAN (evolved-UTAN) comprising a plurality of evolved Node-Bs (eNBs) in the LTE system. The UEs can be devices such as mobile phones, computer systems, etc. Besides, the network and the UE can be seen as a transmitter or receiver according to transmission direction, e.g., for uplink (UL), the UE is the transmitter and the network is the receiver, and for downlink (DL), the network is the transmitter and the UE is the receiver.

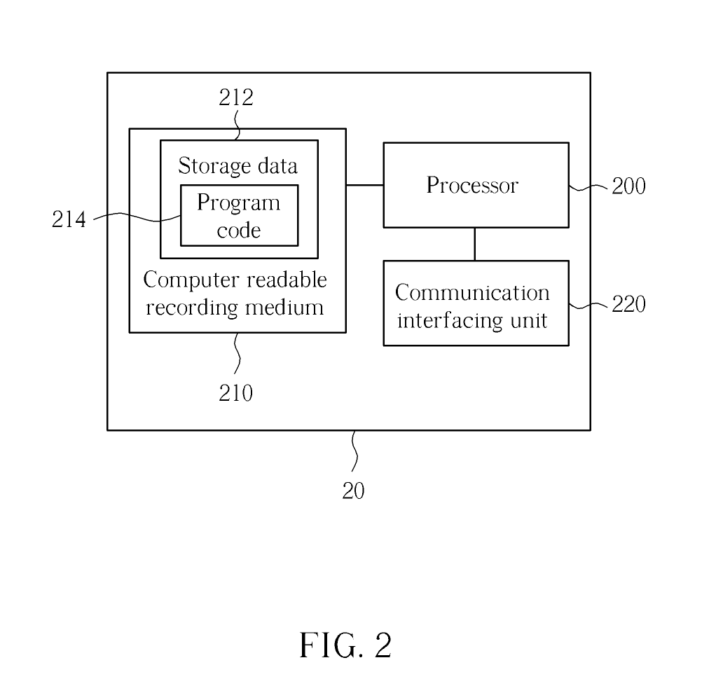

Please refer to FIG. 2, which is a schematic diagram of an exemplary communication device 20. The communication device 20 can be the UE or the network shown in FIG. 1 and includes a processor 200, a computer readable recording medium 210 and a communication interfacing unit 220. The computer readable recording medium 210 may be any data storage device that stores storage data 212, including program code 214, thereafter read and processed by the processor 200. Examples of the computer readable recording medium 210 include a subscriber identity module (SIM), read-only memory (ROM), random-access memory (RAM), CD-ROMs, magnetic tapes, hard disks, optical data storage devices, and carrier waves (such as data transmission through the Internet). The communication interfacing unit 220 is preferably a radio transceiver for wirelessly communicating with other communication devices and can transform process results from the processor 200 into radio signals.

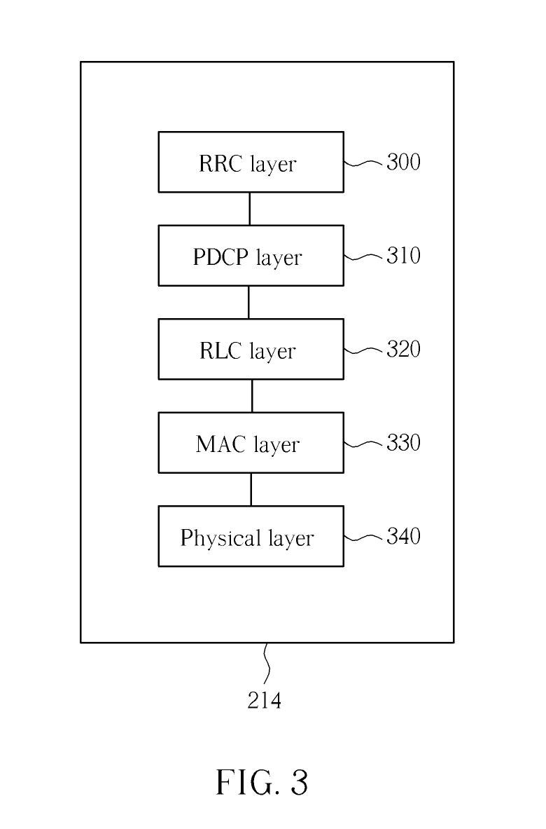

Please refer to FIG. 3, which illustrates a schematic diagram of the program code 214 for the LTE system according to an example. The program code 214 includes program code of multiple communications protocol layers, which from top to bottom are a radio resource control (RRC) layer 300, a packet data convergence protocol (PDCP) layer 310, a radio link control (RLC) layer 320, a medium access control (MAC) layer 330 and a physical (PHY) layer 340. The MAC layer 330 supports discontinuous reception (DRX) functionality. The DRX functionality is executed by the MAC layer 330 according to Radio Resource Control (RRC) commands of the RRC layer 300. The DRX functionality is applied to allow the UE to enter a standby mode during certain periods of time and stopping monitoring a Physical down Link Control Channel (PDCCH), so as to reduce power consumption of the UE.

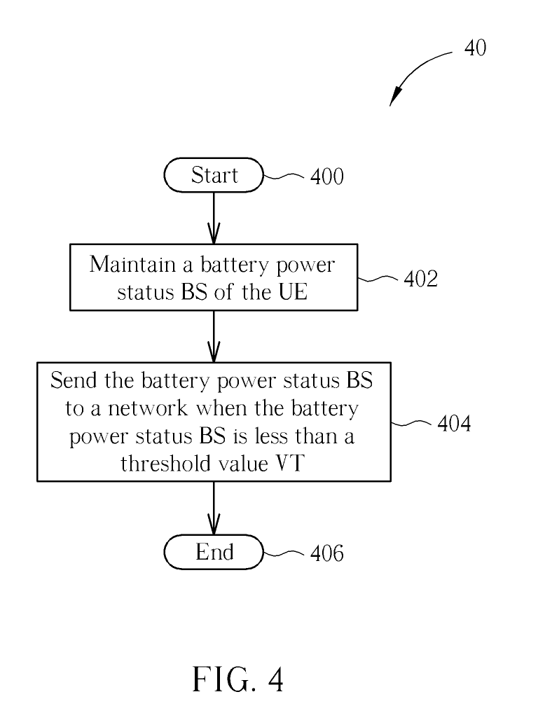

Please refer to FIG. 4, which is a flow chart of an exemplary process 40. The process 40 is used for optimizing power saving for a UE in a wireless communication system. The process 40 can be compiled into the program code 214 and include the following steps:

Step 400: Start.

Step 402: Maintain a battery power status BS of the UE.

Step 404: Send the battery power status BS to a network when the battery power status BS is less than a threshold value VT.

Step 406: End.

According to the process 40, the UE may maintain the battery power status BS and send the battery power status BS to the network when the battery power status BS is less than the threshold value VT. The battery power status BS may be sent in a dedicated signaling or any of existing management messages. The dedicated signaling may be referred as to an RRC message, a MAC protocol data unit (PDU), a MAC control element, physical layer signaling. The existing management messages may be referred as to information element (IE) or radio resource management (RRM). In other words, when the UE's battery goes lower than the threshold value VT, the UE informs the network of the low battery by sending the battery power status BS. Therefore, the network may beware of the low battery and take corresponding actions to reduce power consumption for the UE.

The threshold value VT is a configurable parameter in the UE. Preferably, the threshold value VT is configured by the network and sent in system information. Namely, the different network may configure the different threshold values. For example, a cell C1 served by a network NT1 may set a threshold value VT1 as one-third full battery power. When the battery power status BS of the UE goes below one-third full battery power, the UE in the cell C1 sends the battery power status BS to the network NT1. A cell C2 served by a network NT2 may set a threshold value VT2 as one-forth full battery power. When the battery power status BS of the UE goes below one-forth full battery, the UE in the cell C2 sends the battery power status BS to the network NT2. In some examples, the UE is firstly located in the cell C1, having the battery power status BS lower than the threshold value VT1 but higher than the threshold value VT2. In this situation, the UE sends the battery power status BS to the network NT1. Later, the UE hand over to the cell C2. Since the battery power status BS is greater than the threshold value VT2, the UE does not send the battery power status BS to the network NT2 and the network NT2 considers the battery power status BS of the UE a full battery power. It is possible for the network NT2 not to support the battery power status BS. After the UE completes the handover procedure, the network NT2 will provide information to the UE(using system information, MAC CE, etc) to indicate whether the battery power status BS is supported.

When the UE is charged and gets the battery power status BS back to a value higher than the threshold value VT, the UE may inform the network of increasing of the battery power status BS by sending a dedicated signaling or any of existing management messages.

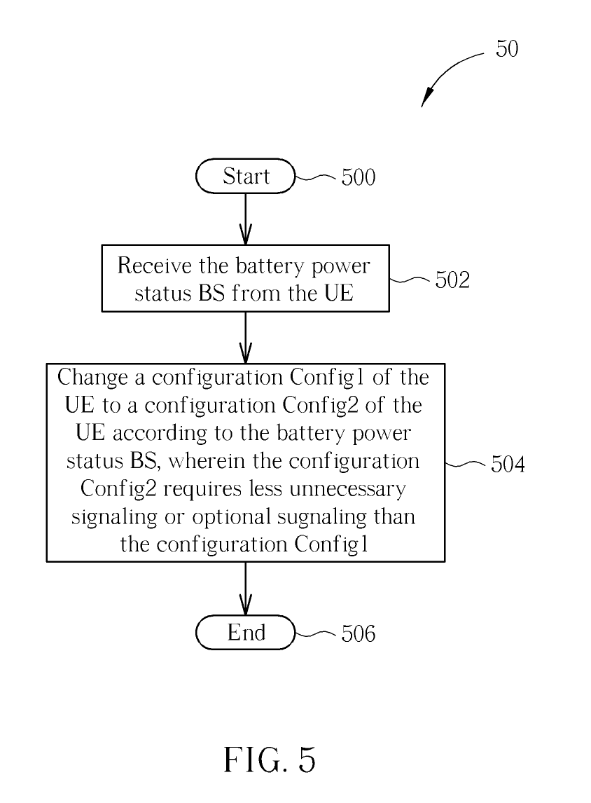

Please refer to FIG. 5, which is a flow chart of an exemplary process 50. The process 50 is used for optimizing power saving for a network in a wireless communication system. The process 50 can be compiled into the program code 214 and include the following steps:

Step 500: Start.

Step 502: Receive the battery power status BS from the UE.

Step 504: Change a configuration Config1 of the UE to a configuration Config2 of the UE according to the battery power status BS, wherein the configuration Config2 requires less unnecessary signaling or optional signaling than the configuration Config1.

Step 506: End.

According to the process 50, after receiving the battery power status BS from the UE, the network changes the configuration Config1 to the configuration Config2 according to the battery power status BS. The configuration Config2 has less unnecessary signaling than the configuration Config1. The unnecessary or optional signaling may be referred as to a management message, a commercial message or any optional message sent to the mobile device or sent from the UE (e.g. optional MDT logs reports, optional UE measurement reports etc). In other words, after the reception of the battery power status BS, the network changes UE's system configuration (from the Config1 to the Config2) to postpone all unnecessary signaling to/from the UE. Therefore, when the batter power status BS is lower than the threshold value VT the UE only receives or sends important signals and management messages, thereby reducing power consumption and optimize the configuration of the UE.

Once the UE recovers its battery power, the network receives an indication Int from the UE. The indication Int indicates the battery power status BS is greater than the threshold value VT. The network reconfigures the UE back to the configuration Config1 according to the indication Int so transmission of all management messages or commercial messages are resumed after the battery power status BS is greater than the threshold value VT.

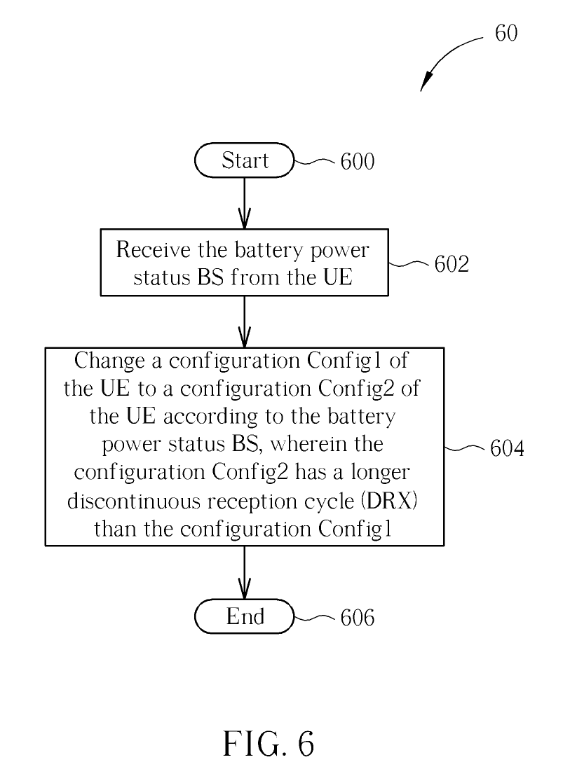

Please refer to FIG. 6, which is a flow chart of an exemplary process 60. The process 60 is used for optimizing power saving for a network in a wireless communication system. The process 60 can be compiled into the program code 214 and include the following steps:

Step 600: Start.

Step 602: Receive the battery power status BS from the UE.

Step 604: Change a configuration Config1 of the UE to a configuration Config2 of the UE according to the battery power status BS, wherein the configuration Config2 has a longer discontinuous reception cycle (DRX) than the configuration Config1.

Step 606: End.

According to the process 60, after receiving the battery power status BS from the UE, the network changes the configuration Config1 to the configuration Config2 according to the battery power status BS. The configuration Config2 has a longer DRX cycle than the configuration Config1 for the UE in an idle mode. The network may force the UE to enter the idle mode (e.g. RRC IDLE mode) according to the battery power status BS when no message is exchanged between the network and UE. In other words, when the network receives the battery power status BS indicating the battery power status is lower than the threshold value VT, the network forces the UE to enter the idle mode earlier when no message is exchanged between the UE and network. Consequently, for the UE with a low battery power status, the UE enters the idle mode when no message is exchanged, thereby saving more power and improving the system overall performance. Furthermore, if several UEs are in the wireless communication system, the network may also change the idle mode configuration to longer DRX for all UEs if this does not hurt the other UEs not concerned by the low battery status.

Once the UE recovers its battery power, the network receives an indication Int from the UE. The indication Int indicates the battery power status BS is greater than the threshold value VT. The network reconfigures the UE back to the configuration Config1 according to the indication Int so the UE could have the original DRX cycle, if the DRX cycle was changed.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20 in which the processor 200 processes the program code 214 related to the abovementioned processes and the processed results can perform feedback load reduction in the wireless communications system 20.

To sum up, the UE sends the battery power status to the network when the battery power status is lower than a threshold value. According to battery power status received from the UE, the network may change the UE's configuration to reduce unnecessary signaling or non important messages sent to/from the UE, thereby reducing power consumption for the UE. In another example, after receiving the battery power status sent by the UE, the network forces the UE to enter the idle mode and may redefine a longer DRX cycle if configurable on the other UEs with full battery. Once the UE gets its power back, the UE sends an indication to the network to inform increasing of the battery power status. When the network receives the indication, the network changes the modified configuration back to the original information. As a result, all message postponed can be resume after UE's power is back.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of power saving for a mobile device in a wireless communication system, the method comprising:
maintaining a battery power status of the mobile device; and
sending the battery power status of the mobile device to a network when the battery power status is less than a threshold value.

2. The method of claim 1, wherein the power status is transmitted in a radio resource control (RRC) message, a media access control (MAC) message, a MAC control element, physical layer signaling or an existing management message.

3. The method of claim 1 further comprising sending a dedicated signaling or an existing management message signaling to inform the network of increasing of the battery power when the battery power status is greater than the threshold value.

4. The method of claim 1 further comprising receiving a command from the network to change a first configuration to a second configuration of the mobile device after the mobile device sends the battery power status to the network.

5. The method of claim 4, wherein the second configuration includes less optional signaling than the first configuration and the optional signaling is a management message or a commercial message sent to the mobile device, or a management message or a MDT log report or a measurement report sent from the mobile device.

6. The method of claim 4, wherein the second configuration has a longer discontinuous reception cycle (DRX) than the first configuration.

7. The method of claim 4 further comprising entering an idle mode earlier according to the low battery power status when no message is exchanged between the network and the mobile device.

8. A method of power saving for a network in a wireless communication system, the method comprising:
receiving a low battery power status from a mobile device; and
sending a first command to the mobile device to change a first configuration of the mobile device to a second configuration according to the low battery power status.

9. The method of claim 8, wherein the second configuration includes less optional signaling than the first configuration and the optional signaling is a management message or a commercial message sent to the mobile device, or a management message or a MDT log report or a measurement report sent from the mobile device.

10. The method of claim 8 further comprising:
receiving an indication from the mobile device, wherein the indication indicates the battery power status is greater than a threshold value; and
sending a second command to the mobile device to reconfigure the mobile device back to the first configuration according to the indication.

11. The method of claim 8, wherein the second configuration has a longer discontinuous reception cycle (DRX) than the first configuration.

12. The method of claim 8 further comprising forcing the mobile device to enter an idle mode earlier according to the low battery power status when no message is exchanged between the network and the mobile device.

13. A system for power saving in a mobile device, the system comprising:
a processor;
a storage component;
a communications component configured to communicate with a network;
a status component configured to maintain a battery power status of the mobile device; and
a trigger component configured to decide sending the battery power status of the mobile device to the network when battery power status is less than a threshold value.

14. The system of claim 13, wherein the power status is transmitted in a radio resource control (RRC) message, a media access control (MAC) message, a MAC control element, physical layer signaling or an existing management message.

15. The system of claim 13, wherein the communication component is further configured to receive a command from the network to change a first configuration to a second configuration of the mobile device after the mobile device sends the battery power status to the network.

16. The system of claim 15, wherein the second configuration includes less optional signaling than the first configuration and the optional signaling is a management message or a commercial message sent to the mobile device, or a management message or a MDT log report or a measurement report sent from the mobile device.

17. The system of claim 15, wherein the second configuration has a longer discontinuous reception cycle (DRX) than the first configuration.

18. The system of claim 15 further comprising entering an idle mode earlier according to the low battery power status when no message is exchanged between the network and the mobile device.
